(19) United States
(12) Patent Application Publication
(10) Pub. No.: US 2011/0153492 A1
(43) Pub. Date: Jun. 23, 2011

(54) CONTROLLING A COMPUTER SYSTEM ENABLING SHARIA-COMPLIANT FINANCING

(76) Inventors: Thomas R. Gainor, Reston, VA (US); Mohamad Lutfi Hammour, Paris (FR)

(21) Appl. No.: 11/720,903

(22) PCT Filed: Dec. 6, 2005
(86) PCT No.: PCT/US05/44279

§ 371 Date: Oct. 23, 2009

Related U.S. Application Data
(60) Provisional application No. 60/633,638, filed on Dec. 6, 2004.

(51) Int. Cl. G06Q 40/00

(52) U.S. Cl. 705/39

(57) ABSTRACT

A computer system including data processing means arranged for receiving information into memory, the information enabling a transaction wherein a first party obtains property financing from a first financier by providing equitable title to the first financier and incurring obligations under a lease to the property, and wherein the first financier obtains funding for the financing from a second financier by providing at least some of the first financier's rights in the property, wherein the data processing means includes control means disposed to apply a Sharia compliance standard to the information control the computer system in carrying out a transaction compliant with the standard.

### PRIORITY DATA

This patent application is a continuation-in part of U.S. Patent Application Ser. No. 60/633,638 titled “COMPUTER-AIDED SHARIAH-COMPLIANT FINANCING SYSTEM FOR MULTI-FAMILY DWELLINGS,” filed Dec. 6, 2004, which is incorporated by reference. This application also incorporates by reference, U.S. patent application Ser. No. 10/406,010, titled “DECLINING BALANCE CO-OWNERSHIP FINANCING ARRANGEMENT,” filed Apr. 3, 2003 and U.S. patent application Ser. No. 10/680,474, titled “COMPUTER SYSTEM FOR SHARIAH-COMPLIANT COMPUTER-AIDED METHOD FOR SECURING A SHARIAH-COMPLIANT CREDIT ENHANCEMENT,” filed Oct. 7, 2003.

### COPYRIGHT NOTICE

The disclosure of this patent document contains material which is subject to copyright protection. The copyright owner has no objection to reproduction by anyone of the patent document or patent disclosure as it appears in the Patent and Trademark Office patent file or records, or any other fair use, but otherwise reserves all copyright rights whatsoever.

### BACKGROUND OF THE INVENTION

A. Field of the Invention

The present invention pertains to a computer system and digital signal processing, and control thereof. For example, the present invention relates to a machine and a data processing system, methods of making and for using the machine, products produced thereby, manufactures, as well as data structures and articles of manufacture pertaining thereto, and all necessary intermediates of that which is discussed herein. More particularly, this invention relates to controlling a data processing system having particular utility in technical and industrial fields related hereto, as exemplified in a system enabling a (non-interest based) Sharia-compliant investment. Still more particularly, the present invention can pertain to controlling a system enabling a Sharia-compliant investment of the type used for multi-family lease activities, such as those somewhat analogous to mortgage crediting, along with automated generation of related documentation, inter-computer communications, networking, and a vertical system utilizing this type of investment.

2. Background Art

Discovered is a gap in the emerging Sharia-compliant investment market for high quality, liquid, intermediate-term and/or long term fixed-rate investments that are “asset based” and allow investors to move up the yield curve. The current market offers non-marketable “debt based” investment instruments, low-credit leasing investments with limited liquidity, and the recent floating-rate emerging-markets sovereign securities.

A constraint that affects fixed-income investments under Sharia relates to the unacceptability of the charging of interest on borrowed funds (“riba”). Under this constraint, cash-for-cash transactions ought not to carry a profit, even if payment is deferred; but cash-for-goods transactions may carry a profit. Thus, a loan (cash today in exchange for cash tomorrow) may not carry an interest rate; but a deferred payment sale transaction (goods today in exchange for cash tomorrow) can be acceptable.

This second constraint has a special application to the sale of debts. Because this kind of sale is considered an exchange of cash due tomorrow for cash today, under Sharia, debts may only be sold at their receivable value, which may not be subject to a discount. Pure debts are therefore not marketable instruments under Sharia.

These constraints, however do not rule out fixed-income financing. There can be alternative “asset based” fixed-income financing structures to interest-bearing loans that are acceptable under Sharia. Contrary to debt-based financing, asset-based financing structures can create marketable investments under Sharia. They involve the trading of a good for cash. One such “asset based” financing structure which is commonly used to finance commercial real estate properties, is lease-to-own financing (Ijara). Under the structure, the financier purchases the asset to be financed and leases it to the recipient of financing, who acquires it fully at the end of the term of the relationship.

The effective implications of asset-based Sharia requirements create liability issues (such as third-party tort liability and environmental claims) for the financier. In an ijara transaction, the recipient of financing conveys the property to the financier and in turn, the financier leases the property back to the recipient of financing for a certain term. Upon maturity date, the property is conveyed back to the recipient of financing. This structure gives rise to potential liability issues for a financier which are over and above what a lender is subjected to in the conventional mortgage finance market. (A conventional lender only has a lien on a property and has no ownership stake in the asset.)

In carrying out the foregoing, there have been significant needs regarding such as efficiency and/or security, with manual systems being prone to manual problems, and with automated variants having limitations regarding control and management of corresponding computer resources as applied to prior art approaches.

### DISCLOSURE

In the area of said technical field, representatively: an apparatus for controlling a computer or computer system. Representatively, there can be an apparatus including data processing means arranged to receive information into memory, the information enabling a transaction wherein a first party obtains property financing from a first financier by providing equitable title to the first financier and incurring obligations under a lease to the property, and wherein the first financier obtains funding for the financing from a second financier by providing at least some of the first financier's rights in the property, wherein the data processing means includes control means disposed to apply a Sharia compliance standard to the information control the computer system in carrying out a transaction compliant with the standard.

Also representatively, there can be an apparatus controlling a computer system enabling a transaction, the apparatus comprising: data processing means arranged for receiving information into memory, the information enabling a transaction wherein a first party obtains property financing from a first financier by providing equitable title to the first financier and incurring obligations under a lease to the property, and wherein the first financier obtains funding for the financing from a second financier by providing at least some of the first financier's rights in the property, wherein the data processing means includes control means disposed to apply a Sharia compliance standard to the information to control the computer system in carrying out the transaction compliant with the standard.

From another perspective, there can be an apparatus controlling a computer in a system enabling a transaction, the apparatus comprising: a plurality of computers programmed to cooperate in enabling a transaction wherein a first party obtains property financing from a first financier by providing equitable title to the first financier and incurring obligations under a lease to the property, and wherein the first financier obtains funding for the financing from a second financier by providing at least some of the first financier's rights in the property; data processing means, at one of the computers, arranged for receiving information into memory, the information defining a portion of the transaction; and control means disposed to apply a Sharia compliance standard to the information to control the one of the computers in carrying out the transaction compliant with the standard. Such an embodiment can further include data processing means, at a second of the computers, arranged for receiving respective information into memory, the respective information defining a portion of the transaction; and control means disposed to apply a respective Sharia compliance standard to the respective information to control the second of the computers in carrying out the transaction compliant with the respective standard. And in the foregoing example, and otherwise, the standard and the respective standard need not be identical.

In any of the foregoing, and in other embodiments herein, the property can be a multifamily dwelling property, a single family dwelling property, or neither a single family dwelling property nor a multifamily dwelling property.

Note that methods of use are indicative of corresponding computer systems and corresponding methods of making, as well as the data and communications that form necessary intermediates.

### BRIEF DESCRIPTION OF THE DRAWINGS

FIG. 1 shows an overview flow chart.

FIG. 2 shows an overview flow chart.

### MODES

The accompanying drawings illustrate embodiments intended to exemplify in a teaching manner.

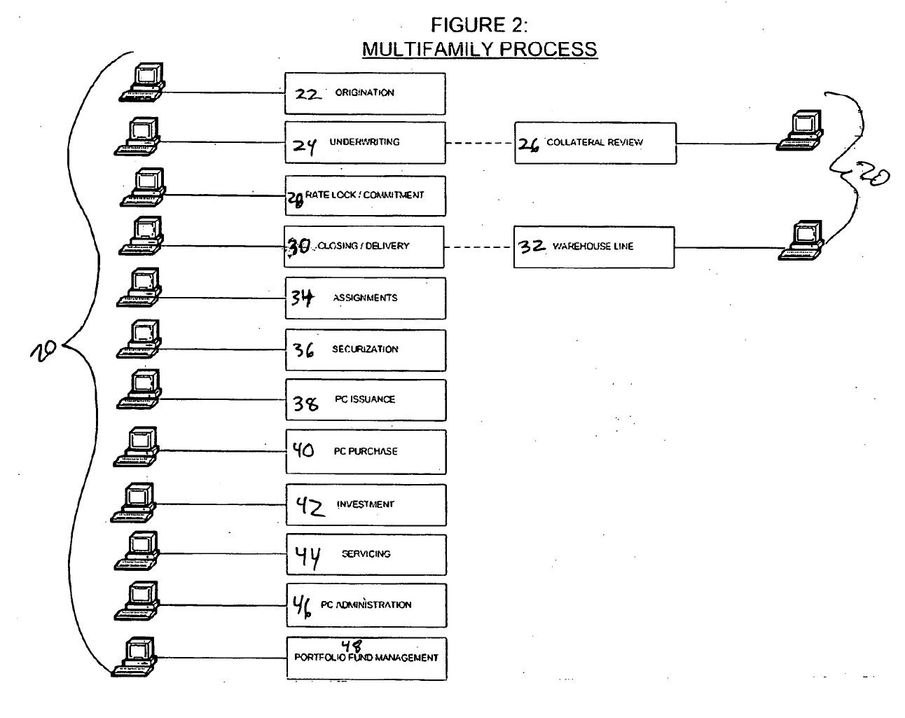

As used herein, the term computer generally refers to hardware or hardware in combination with one or more program(s), such as can be implemented in software, hardware, or a combination thereof. Computer aspects can be implemented on general purpose computers or specialized devices, and can operate electrically, optically, or in any other fashion. A computer or computer system as used herein can be viewed as at least one computer having all functionality or as multiple computers with functionality separated to collectively cooperate to bring about the functionality. Logic flow can represent signal processing, such as digital data processing, communication, or as evident from the context hereinafter. Logic flow can be implemented in discrete circuits. Collectively see computers 20 in FIG. 2. Computer-readable media, as used herein can comprise at least one of a RAM, a ROM, a disk, an ASIC, and a PROM. Industrial applicability is clear from the description, and is also stated below. Note in this regard, the control of a computer system herein, which can be by a switching system enabling control of one or more digital devices or computers, can be resident at one or more of the computers shown in FIG. 2.

As illustrated in FIG. 2, computers 20 may have an input device such as a keyboard, an output device such as a monitor screen and/or printer, a computer-to-computer communication device such as a modem, and a memory holding data and program, or the data and program can be separately located. The program can be software stored on such as a disk or a program burned into ROM, depending on the implementation desired. In an embodiment herein, there can be a computer-readable media or memory tangibly embodying a program of instructions is executable by the computer system to perform the steps corresponding to functions discussed subsequently.

By way of the following prophetic teaching, there is provided computer support, as in a data processing system, for implementing aspects of parts of, or from, a financial product or instrument to accomplish certain financial objectives to and advance such as efficiency and/or security, over said manual systems and corresponding problems, and automated variants having limitations regarding management of corresponding computer resources.

First, though, consider some context. In general, in solving the aforementioned problem and preferably provide liquid, fixed-income investments to Sharia-compliant investment market, while addressing the potential liability issues to the financier, there can be property (e.g., any property e.g., a single family dwelling, a multi-family dwelling, neither, e.g., a airplane or ship). Herein the property is exemplified in connection with a multifamily finance product: The Multifamily Finance product can use a “Multifamily Finance Lease” or “MFL” that can (i) satisfy the needs and expectations of the multifamily housing industry, (ii) back the issuance of securities by Freddie Mac or equivalent institutions, in a way that closely resembles or emulates multifamily mortgage backed securities or Participation Certificates (the “PC”) and (iii) manage portfolio/fund 12 which can invest in such investment instruments. In a Sharia-compliant embodiment, compliance can be based on a predefined Sharia standard (e.g., test for penalties, rights in property, combination thereof, etc.). However, the financial product embodiments need not be limited to Sharia compliance.

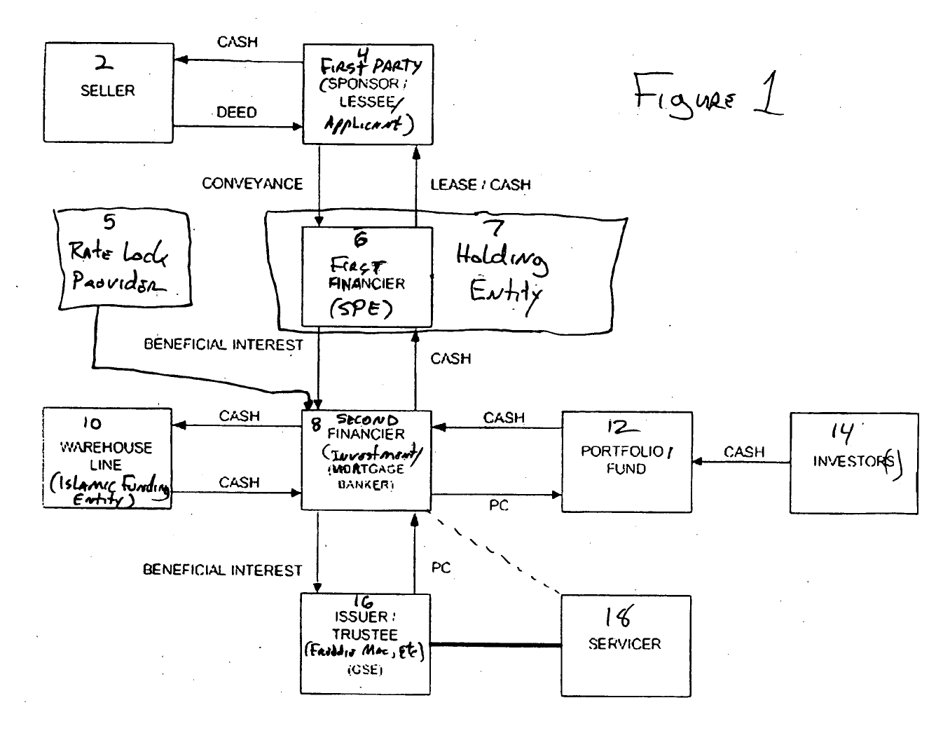

Turn now to FIG. 1 for exemplification. A financial product according to an embodiment herein can use a lease between a first party 4 recipient of financing and a first financier 6. The second financier 8 can be insulated from potential liabilities of ownership by stripping potential liabilities via an entity the first fancier 6. Note that the first party can also be an entity such as a SPV and this limits liabilities to only those associated with the property. The first financier 6 is a SPV and incur a liability risk and is remote based on the terms of the agreements taken as a whole and limited to the property, in any event—first financier 6 assigns its interests in the property which includes what it has, less certain liabilities (e.g., Limited Liability Corporation or special purpose entity). So for example, in effect the insulating is carried out by contract, whereby a second first financier 8 and any subsequent assignees are insulated from the potential liabilities of equitable ownership of the financed property deeded by seller 2 to buyer or first party 4.

The proposed financing can be made suitable for the secondary market, e.g., asset-backed or mortgage-backed securities. In a Sharia standard complaint embodiment, a financial product backed by the financing can be structured to offer high-quality, marketable investment instrument. Such an investment can inherit liquidity from the conventional asset-backed securities market and can be designed to mimic and benefit from the guaranty of an issuer/trustee 16, such as a government sponsored enterprise (GSE), e.g., Freddie Mac or Fannie Mae, thus, resulting in the implicit guaranty (illustrated in the US context) of the U.S. government. Of course other such arrangements in other nations can be carried out in analogous manner.

In another embodiment, there can be a portfolio and/or a fund 12 which invests in such GSE securities that include at least one of the aforementioned products or Sharia-compliant products. Institutional investors in the Sharia-compliant investor(s) 14 market, as well as other desiring this product, can benefit from such a high-quality, liquid asset-based investment product.

More particularly, with further reference to FIG. 1, the first-party 4 (sponsor, lessee financing applicant, and/or borrower in a conventional mortgage sense) seeking property financing either has title to the property (in a refinance scenario) or obtains title from a seller 2, in a purchase whereby money is convened in association with conveyance of a deed in a financing transaction for the property. The first party 4 conveys good and marketable equitable and beneficial title to a first financier 6 (e.g., a special purpose entity (LLC) or other bankruptcy-remote entity) through a sale that is structured through one or more payments. The LLC, as the first financier 6, demises and leases the property back to the first party 4 for a specified term and has provided money to pay off an existing creditor (refinance scenario) or third-party seller (purchase scenario). These can be structured in separate agreements. The first party 4, as the lessee, is ultimately responsible for maintenance and management of the property. The LLC, as the first financier 6, conveys its beneficial interest (except for certain third party liability) in the property, in exchange for funds from second financier 8 (e.g., an investment or mortgage banker). The second financier 8 can be responsible for initiating and executing the origination and servicing of the multifamily transaction. In such an embodiment, the second financier 8 obtains cash to provide financing (in some embodiments for a minimal fee) from an funding entity (such as a warehouse line provider) 10. In Sharia-compliant embodiments, the financing is provided in a manner that is Sharia-compliant as a purchase and/or sale.

In one embodiment, the second financier 8 can in turn, convey its interest in the property to another party, such as an issuer/trustee 16, such as a government-sponsored enterprise (GSE, e.g., in US context, Freddie Mac or Fannie Mae or equivalent to any of the foregoing). A GSE can act as an issuer/trustee 16 of Participation Certificates (PCs) or other similar interests. The issuer/trustee 16 can issue PCs wrapped with its credit enhancement and backed by the Sharia-standard compliant multifamily financing to the second financier 8. The second financier 8 conveys the PCS to a portfolio or fund 12 in exchange for cash. The cash received from the portfolio or fund 12 replenishes the second financier 8 against the cash it provided to the first financier 6 at the origination stage, which in turn, the second financier 8 uses to replenish the warehouse line provider 10. The portfolio or fund 12 provides fixed-income returns from the PCs to investors in exchange for cash.

Turning now more particularly to computer science aspects of the foregoing, there can be a computer system and method for making it and method for using it. Exemplifying via the method of use as a teaching thereof, with further elucidation herein, consider a computer-aided method, the method including: converting input information, representing a first party financing property by providing equitable title and incurring obligations under a lease to the property with a first financier, into input signals; converting input information, representing a first financier obtaining funding for the financing from a second financier by providing at least some of the first financier's rights in the property received from the first party, into input signals; communicating the input signals to a computer system; computing, with the computer system, to process data corresponding to the input signals to produce an illustration of an arrangement of the funding and the financing; and producing, at an output device in communication with the computer system, an illustration of the arrangement. Any embodiment can be carried out further including evaluating the arrangement according to a predefined Sharia compliance standard.

Another embodiment can be viewed as a computer-aided method, the method including: entering into a computer system data defining an arrangement in which a first party obtains financing for property by providing equitable title and incurring obligations under a lease to the property with a first financier, and the first financier obtains funding for the financing from a second financier by providing at least some of the first financier's rights in the property received from the first party, wherein the arrangement complies with a predetermined Sharia compliance standard; computing, with the computer system, to process the data to generate an optimization of the arrangement; and producing, with the computer system, implementation documentation to carry out the arrangement according to the optimization.

In any embodiment, the producing implementation documentation can include producing documentation according to a predefined Sharia compliance standard.

Yet another embodiment can be viewed as a method for monitoring a financing arrangement, the method including: monitoring, with a computer, notice of at least one payment required from a first party, the payment defined by an obligation corresponding to a lease corresponding to financing from a first financier receiving equitable title to the property and associated with funding for the financing obtained from a second financier receiving a beneficial interest in the property; determining, electronically, whether the obligation is not violated; if the obligation is violated, signaling a notice of the violation; determining, electronically, whether the obligation is satisfied for a corresponding time period; if the obligation is satisfied for the time period, then repeating the monitoring for a subsequent time period; determining, electronically, whether the obligation is completely satisfied; and if the obligation is completely satisfied, then signaling a notice that the obligation is completely satisfied, and terminating the monitoring to correspond with exercising an option by the first party to obtain full right, title, and interest in the property. Such a method can further include defining the obligation pursuant to a predefined Sharia compliance standard.

Still another embodiment can be viewed as a computer-aided method, the method including: storing in a computer memory a data structure recording a multiplicity of financings defined by respective agreements wherein, respectively, a first party obtains financing for property by providing equitable title and incurring obligations under a lease to the property with a first financier and whereby the first financier obtains funding for the financing from a second financier by providing at least some of the first financier's rights in the property received from the first party, at least one of the financings being compliant with a Sharia standard; updating the data structure with payment data; identifying from the payment data any of the financings in which all said obligations have been satisfied; and for each of the financings in which all said obligations have been satisfied, generating notice of an option defined as exercisable by the first party so as to cause the interests to vest in the first party.

A further embodiment can be viewed as computer-aided method, the method including: forming a data standard by eliciting data with a Sharia-compliance lending template, the template including data fields configured to receive entry of data defining an arrangement of a first party obtaining financing for property by providing equitable title and incurring obligations under a lease to the property with a first financier, and the first financier obtaining funding for the financing from a second financier by providing at least some of the first financier's rights in the property received from the first party; and storing in a memory of a computer data structured in accordance with the data standard.

Further, another embodiment can be viewed as a method of using a computer system to implement a financing, the method including: providing a database of data relating to applications for financing property according to a Sharia-compliance standard, wherein the applications are defined by: obtaining, at a first party, financing for property by providing equitable title and incurring obligations under a lease to the property with a first financier, and obtaining, at the first financier, funding for the financing from a second financier by providing at least some of the first financier's rights in the property received from the first party; and testing an indicator in the database, the indicator indicating status of the applications; and a program accessing the database to analyze the status in carrying out at least one closing corresponding to at least one of the applications.

Further still another embodiment can be viewed as a computer-aided method for carrying out an option on a financing, the method including: receiving information into a memory specifications defining the option to acquire property, the option defined in accordance with a Sharia standard-compliant transaction in which a first party obtains financing for property by providing equitable title and incurring obligations under a lease to the property with a first financier, and the first financier obtains funding for the financing from a second financier by providing at least some of the first financier's rights in the property received from the first party, such that satisfaction of the obligations enables execution of the option so that the first party extinguishes the interests; evaluating satisfaction of the obligations with a computer; and if complete satisfaction is detected, signaling enablement of the option.

Further yet still another embodiment can be viewed as a method of generating financing documentation, the method including: providing a database of data containing model documents corresponding to financing structured according to a Sharia-compliance standard, wherein the model documents are defined by: obtaining, at a first party, financing for property by providing equitable title and incurring obligations under a lease to the property with a first financier, and obtaining, at the first financier, funding for the financing from a second financier by providing at least some of the first financier's rights in the property received from the first party; and controlling a computer system with a program to enable an analysis of the funding structure applied to a property, enable access to the database to obtain at least one of the model documents, and enable modification the at least one document in carrying out an acquisition of the property.

And yet another embodiment can be viewed as a computer-aided method for producing an asset-backed security, the method comprising: storing in a computer memory a plurality of financing arrangements, at least one of the financing arrangements defined by: a first party obtaining property by providing equitable title and incurring obligations under a lease to the property with a first financier, and the first financier obtaining funding from a second financier by providing at least some of the first financier's rights in the property received from the first party; identifying at least one of the financing arrangements that is compliant with a predefined Sharia standard; and forming an asset-backed security including the at least one of the financing arrangements that is compliant with a predefined Sharia standard, by preparing documentation operatively associating the set of multiple financing arrangements with the security.

An article corresponding to method implementation can include computer-readable media tangibly embodying a program of instructions executable by a computer to perform any of the method steps indicated herein. The media can include at least one of a RAM, a ROM, a disk, an ASIC, and a PROM.

In carrying out an embodiment herein, one may utilize the system described in Ser. No. 10/680,474 in cooperation herewith or by modification thereof so as to carry out the unique aspects herein.

Turn now to the prophetic embodiment of a diagramed in FIG. 2. The computing can be coordinated with the second financier 8 for the origination of the financial product. A second financier 8 network can serve as a distribution correspondent originating finance products for the portfolio or fund 12 as well as a servicer 18 of the financing contractual arrangements. The dotted line connecting second financier 8 and servicer 18 represents the possibility that in some embodiments the second financier 8 can also be the servicer 18.

The multifamily or other such finance program can operate under an agreement with the issuer/trustee 16 through which the issuer/trustee 16 can essentially swap each financing contract for a PC backed by the corresponding finance documentation. There can be a further agreement with a rate lock provider 5. The rate lock provider 5 can provide daily pricing to the second financier 8 for the purposes of originating the finance product.

A. Origination 22

The second financier 8 can utilize its existing origination network for transmitting and receiving communication, external to the second financier 8 or internally, e.g., to computers of an in-house origination team, enabling marketing efforts. The origination team, with corresponding computer support, initiates acquisition and refinancing requests from multifamily property owners for consideration by the issuer/trustee 16 for the portfolio or fund 12.

Computer-generated sales materials, as well as unique documentation, can be output to apply to individual needs, such as enabling a purchase or enabling a change from a prior financial product (e.g., mortgage) to an embodiment such as discussed herein. Optionally, an incentive can be offered to offset the “transaction cost” of switching to a new product. In any case, embodiments can include generating, by computer, custom documents helping explain the transaction components and the nature of the emulating of a traditional mortgage, including vocabulary, such as the contrast between traditional mortgage interest and profit, and principal and principal rent. Computer-processed data, in accordance with unique characteristics of embodiments discussed herein, can be inserted into stored model documents.

The origination phase can involve extensive communication and exchange of information among the second financier 8, the first party 4, and potentially others to perform a computer-assisted analysis of the viability of a particular transaction, e.g., credit worthiness of the first party 4, valuation of the property, etc. Much of this can involve communication and sharing of information and be facilitated by using computer systems corresponding to the various parties as transmitters and/or receivers of data communications, preferably with the computer systems having computational capabilities and enabled for comparing scenarios.

The second financier 8 can perform initial computer-aided analysis to determine potential and general viability of a transaction. The analysis can include a net income calculation and one akin to a debt service ratio, which in turn requires analysis of expenses for the property, cost of financing, etc. to determine whether, and by how much, income from the property exceeds cost, with the excess as a percent of expenses, for example. Net income divided by the expense forms the obligation/debt type service coverage ratio. For example, 1.5 corresponds with $150,000 versus the cost of $100,000, including the mortgage. This ratio is a threshold test that can be used to satisfy a provider of funds, akin to a lender. Further analysis of costs, income, leasing, percent of net operating expenses etc. give insight into the potential for a transaction and are used in a debt service like computation.

Further, market analysis (preferably done with computer support) can consider whether similar properties indicate reasonableness of proposed transaction data and assumptions. This computing can be carried out to determine whether a particular financing agreement to value ratio is acceptable. For example, in many cases a ratio above 80% can be set as an indication of high risk for a transaction.

Assuming initial analysis is promising, a first party 4 can complete an application that is entered or transmitted to the second financier 8, preferably utilizing a corresponding computer system receiver. The application, if approved, gives the second financier 8 the exclusive right to provide financing, here in accordance with the transaction exemplified herein. The applicant first party 4 pays an initial cost for an appraisal, engineering studies, title report, survey, attorney costs, etc. as may be needed in a particular case, the foregoing utilizing computer support as well. One objective, depending on the embodiment, can be to prepare a proposed transaction acceptable to a party, such as the issuer/trustee 16.

B. Underwriting 24

The determinations regarding the transaction, its sizing and financing terms, etc., can be is based upon the underwriting of the property and any first party 4 as performed by the second financier 8 computer system, e.g., and consistent with the criteria and authority provided by the agreement with the issuer/trustee 16. The underwriting of the property can involve extensive communication and sharing of information by transmitter and receiver computer systems corresponding to the second financier 8 and third-party service provider(s) including but property inspectors, an appraiser environmental inspectors, etc.

Approval of each financing can be carried out to produce computer output at second financier 8 (e.g., documentation) and/or at the issuer/trustee 16, with transmission/reception occurring between them, e.g., enabling for issuance of a financing agreement to the first party 4. Upon approval and acceptance of the financing contract, the first party 4 can secure the profit rate (rate lock) for the contract.

By utilizing computer support, the issuer/trustee 16 can evaluate the proposed transaction to produce a decision, etc., accept, fund less, have certain restrictions, etc. Where a commitment is given from the issuer/trustee 16 to the second financier 8 (acting as an originator), a commitment is also offered from the second financier 8 to the first party 4 (applicant), again preferably by computer systems.

Viewed another way, the transaction is that the issuer/trustee 16 issues a commitment to purchase the financing from the second financier 8, and the second financier 8 issues a commitment to grant financing to the first party 4 with essentially matching terms but with some added consideration for the second financier 8 to account for cost and/or profit from the work preformed in forming the transaction, and creating, maintaining, or coordinating the efforts of the first financier 6. The consideration may take the forms of profit, origination fee(s), lease payment adjustment fee which is akin to points, money, or any combination thereof, as may be preferred in one transaction or another.

C. Lease Rate Lock/Commitment 26

The process for obtaining a rate lock commitment 28 can be modeled to emulate (though of course not exactly replicate, in view of religious requirements) standard operating procedures, e.g., as observed within the multifamily financing agencies. Program pricing can be established in such a way that the second financier 8 will not be encumbered with an additional approval step over and above issuer/trustee 16 usual process. The process can be coordinated among rate lock provider 5 and the portfolio or fund 12 and the second financier 8. The rate lock provider 5 can utilize an automated system to calculate pricing, including yield concession, for newly originated financing assets to the second financier 8 on a daily basis or otherwise. The rate lock provider 5 computer system can produce a quoted price in yield or spread terms, which can be computed based upon a readily available benchmark security or mortgage loan acquisition program. Pricing can be subject to the issuer/trustee 16 underwriting and acceptance as well as a pre-agreed guaranty-type fee. The rate lock provider commits to the rate in exchange for delivery of a PC by the second financier 8 at an agreed upon date (usually the closing and delivery date which is 45-60 days from the rate lock date). In turn, the second financier 8 provides a commitment to the first party 4 based on the rate provided by the rate lock provider 5.

D. Closing and Delivery 30

The process for closing and delivery 30 can be modeled to emulate (though of course not exactly replicate, in view of religious requirements) standard operating procedures, e.g., as observed within the multifamily financing agencies. The second financier 8 can fund a financing through its warehouse line 10 and deliver the financing to the issuer/trustee 16. An agreement with a reputable national title insurance company can be utilized to support the arrangement. The unique documentation utilized for closing purposes can be computer-generated to mimic the traditional multifamily finance market. For the closing of the transaction, the second financier 8 typically has legal counsel, as does the issuer/trustee 16 and first party 4, seller 2, and others. Documentation and an opinion can be generated and altered by computer. Documentation in accordance herewith is distinctly different from documentation used in traditional mortgages with interest. For example, documentation herein can include a particular lease-type of document suitable for an embodiment consistent herewith, rather than a traditional mortgage-with-interest type of document. This follows because the present transaction is not a mere loan to an owner, but is instead a transaction between an first party 4 owner and a first financier 6, with some rights conveyed to the first financier and leased back to the owner. Lease payments (e.g., monthly) can be portrayed in a way that mimics traditional mortgage documents, but reflects differences flowing from the use of a principal rent and profit rent rather than the usual principal and interest, and the unique other structural features corresponding hereto.

Each transaction can involve a bankruptcy-remote vehicle in the position of first financier 6, such as using at least one special purpose vehicle (e.g., an LLC) established, e.g., by the State of Delaware to act as the initial financier 6. The setting up and administration of the LLC can utilize a computer system. The computer system can generate LLC specific documentation. Each LLC can, for example, be set up as set forth below, but in some embodiments, a plurality of LLCs (i.e., initial financier 6s) can be within a holding entity 7 that serves as Member in a limited liability context:

(i) Directors and Officers

Holding entity 7 can be a special purpose corporation comprised as follows:

Three Managers/Directors

Holding entity 7 that serves as single member can be owned by mortgage bank, must demonstrate segregation, which is done by separate books and records, two independent directors in Delaware and a separate registered agent in Delaware. Holding entity 7 can have two additional directors and may have several officers, including:
President
Vice President
Secretary
4 Assistant Secretaries
   Each first financier 6 special purpose vehicle limited liability will have four managers (one of which will be its sole member) and three individuals. No single individual will serve as both officer as well as manager or director, as the case may be.

(ii) Books and Records

Service agreements can be entered by a separate initial financier 6, and the initial financier 6 can provide all accounting and financial reporting for them.

Meetings can be held on a periodic basis to deal with matters to be brought before the Managers/Board of Directors. Minutes of the meetings are maintained, etc.

(iii) Service Agreements

Both the holding entity 7 and the initial financier 6 can execute service agreements with a third party provider, so as to have no employees and outsource books and records, and otherwise spell out the requirements needed to maintain separateness of initial financier 6 and the holding entity 7.

Service agreements can be used either directly or through an affiliate of the second financier 8 to obtain services as relates to contract servicing for investors and as needed for fulfilling requirements of the financial contracts.

(iv) Fees and Charges

The first party 4 can be responsible for the fees and costs related to the establishing and maintaining the SPE status with the State of Delaware, for example.

The process of formation is computer-aided and preferably fully automated. In another embodiment, it is possible to advance funds to form the SPE LLC in lots of, say, 50 or more to be held and used as closings occur. After the contract has been set-up on the servicing system of the service provider 18, applicable funds collected at closing are disbursed from the first party's 4 escrow account to reimburse the (originator) second financier 8 and the servicer 18.

The annual amounts to maintain the first financier 6 due can be escrowed and collected as part of the first party's 4 monthly payment. As required, the disbursement is made to the state, a registered agent, holding entity 7, second financier 8, and/or servicer 18.

The amounts due to the holding entity 7 and the second financier 8 can be deposited by the service provider 18 into separate bank accounts.

E. Assignments 34

Subsequent to the Closing/Delivery 30, there are two levels of assignments where one party assigns its interest to another. All of the assignments are generated (and can even be executed) using a computer. First, there is an assignment from the first financier 6 of its interest (equitable title) less certain third-party ownership related liabilities to the mortgage banker (second financier) 8. In turn, the second financier 8 assigns all of its interest to the issuer/trustee 16. Each of the assignments mentioned include assignments of financing documents, some of which are recorded in county land records, while others remain unrecorded. The recordation of assignments in the land records can be accomplished via computer too.

F. Securitization 36

At the time that rate is locked with the first party 4, in one embodiment, the second financier 8 can enter into a delivery contract with the portfolio or fund 12 (through the rate lock provider 5) to deliver a PC backed by a finance contract and has a coupon net of the appropriate servicing and guaranty-type fee (fee paid to the GSE for providing a service that results in a credit enhancement). At the time that the contract closes or shortly thereafter, the second financier 8 delivers (assigns) the closed contract to the issuer/trustee 16. The issuer/trustee 16 can utilize internal operations to wrap its guarantee around the contract and issue a PC in exchange for the contract (to all the property interest) to the second financier 8. The internal operations utilized by the issuer/trustee 16 mimic the traditional process and are computer generated. The second financier 8 can, in turn deliver the PC to the portfolio or fund 12 (e.g., through the rate lock provider) at the rate/price that was determined at the date that rate was locked with the first party 4.

G. PC Purchase 40

The rate lock provider 5 can utilize computer support to enable purchasing PCs from the second financier 8 as issued by the issuer/trustee 16 and subsequently, sold to portfolio or fund 12. Further, the portfolio or fund 12 utilizes computer support to communicate and purchase PCs from the rate lock provider 5.

H. Investment 42

One or more investor(s) 14, e.g., Sharia-compliant investors, utilize a respective computer system(s) to communicate with portfolio or fund 12 and invest in the issuer/trustee 16 PCs.

I. Servicing 44

As is the case in the traditional mortgage finance market, the second financier 8 can act as the servicer 18 of the underlying PC collateral, or the servicer 18 can be separate. (This is indicated by the dotted line in FIG. 2.) The servicer 18 administers financing contracts as an agent to the issuer/trustee 16. The servicer 18 can rely on computer support to carry out its functions as the servicer 18. In a very general sense, the main responsibilities of the servicer 18 are to administer the collateral for the benefit of investors 14, deal with any special requests submitted by first party 4 such as assumptions, reconcile and disperse monthly payments, handle default administration, etc. Within these categories, the servicer 18 has many day-to-day functions and responsibilities which can be executed with the corresponding computer system. The servicer 18 can earn a servicing fee to execute its functions such as investor(s) 14 reporting, option exercises/payoff, assumptions, second borrowings, default provision, site inspections and escrow administration, all assisted by computer support.

With particular regard to the options, when first party 4 has met all its obligations under the Multi-Family Lease Agreement and the related agreements, there can be a signal providing that first party 4 may exercise its rights under the Purchase Option to purchase back, at a set price, all equitable and other rights held by financier 8 in the property and extinguish first party 4's financial obligations to financier 8. Financier 8 (any having rights to the property downstream from the first party 4, e.g., the financier 8 or a successor in interest) is obligated to sell such equitable rights upon the exercise of the Purchase Option by first party 4. The signal can be produced by the computer system of financier 8 or the servicer 18 (if it be separate from financier 8) computer. The purchase option signal can be generated in a computer of first party 4. The signal can be generated in the computer of all parties who are successors to the interests of financier 6 in the property including second financier 8, servicer 18, any issue/trustee 16 (guarantor), and the portfolio or fund 12.

If first party 4 fails to meet all its obligations under the Multi-Family Lease Agreement and the related agreements, and does not provide cure of such failure in accordance with the agreements, there is a signal providing that financier 8 may exercise its rights under the Sales Option to sell, at a set price, its equitable rights in the property and first party 4 shall be obligated to purchase such rights. If first party 4 is unable to consummate the purchase then certain additional rights can accrue to financier 8 with respect to its ability to compel the first party 4 and any issue/trustee 16 (guarantor) to perform. The signal can be produced by the computer system of financier 8, or the servicer 18 (if it be separate from the financier 8) computer. The signal can be generated in computer of first party 4. The signal can be generated in the computer of parties who are successors to the interests of financier 6 in the property including second financier 8, servicer 18, any issue/trustee 16, and the portfolio or fund 12.

J. PC Administration 46

As the issuer/trustee of PCs, the issuer/trustee 16 is responsible for the administration of PCs on behalf investors 14. This involves, in a very general sense, reconciling payments received from the servicer 18 and submitting dividends to investors 14, default administration and acting in the overall best interest of securities holders. The issuer/trustee 16 roles and functions as PC administrator are executed with the use of its computer.

K. Portfolio/Fund Management 12

The portfolio or fund 12 can utilize its respective computer for portfolio management and also for marketing purposes. Marketing documentation can include documentation adapted to attract an investor(s) 14 base. Other computing can include managing risks and assets associated with portfolio management.

In embodiments can be carried out with several unique documents, including a conveyance of equitable title from the first party 4 to the first financier 6. Legal title is in the name of the first party 4, but equitable title belongs initially to the first financier 6, and then is leased back to the first party 4 and the rights in the property passed on to those parties who take on the rights of the first financier 6.

Another new document can be a financing document, which is a lease and a demises of the property back to the first party 4.

Still another new document can be a put option document used if the first party 4 is in default, which requires the first party 4 to buy back the equitable interest in the property contract of the present transaction, or if it cannot do so, then a separate mortgage secures the property until a foreclosure is used to take legal title in the usual fashion.

Yet another unique document can be a call option, which is exercised by the first party 4 after the lease obligations have been satisfied. Pursuant to the call option document, after such satisfaction, the first party 4 obtains the property for a nominal amount and the financing terminates. Computer support is used in producing any one or more of these documents.

In carrying out the foregoing transaction, documentation also can be adapted to enable the first financier 6 (LLC) to transfer rights to the second financier 8 who in turn assigns these rights to the issuer/trustee 16. The issuer/trustee 16 provides credit enhancement and issues PCs (or the like) backed by financing documents, functions which preferably involve computing. Unlike other mortgage-backed securities, the present mortgage-backed security is Sharia compliant, e.g., as regards a predefined standard, such as penalty, conditions, and rights in property, Sharia-compliant aspects, or is carried out in association with predefined Sharia-compliance standards, depending on the particular embodiment of interest.

A portfolio or fund 12 (e.g., in the US, e.g., a registered investment company), can be created to utilize an investment advisor and communicate with the second financier 8. The portfolio or fund 12 can give a rate lock (through a rate lock provider 5) on the transaction, and second financier 8 can sell, in effect, rights to the fund 12 for consideration such as dollars. Computer support can be utilized here too to track the warehousing of the special purpose entities. The portfolio or fund 12 does asset management including computerized risk management.

Downstream activities are also preferably carried out with computing support. Institutional investors, banks, pension funds, etc., buy shares in the portfolio or fund 12 and obtain cash flow there from, e.g., Islamic institutions that for the first time use computing in connection with fund transactions involving a Sharia-compliant fund having securitized assets. Computing methods for tracking distributions to investors 14, other tracking in the fund, collateral of the servicer, etc. Such investors 14 also can have corresponding computers adapted to meet their needs in conjunction with the investors 14 functions in a system of FIG. 1.

Note that in connection with the foregoing, there can be an offering memorandum. However, the offering memorandum is of course distinct to reflect the Sharia-compliant aspects. One distinction can involve, depending on the embodiment, a side letter or supplement from the issuer 16, with corresponding computer support therefore.

Also within the scope of the corresponding computing is support of servicing the mortgage related transactions, monitoring payments, generating statements and reports, accounting corresponding to the respective parties in the foregoing, noting declining balances in particular transactions, signaling satisfaction of obligations or conditions for exercising one or the other of the above-mentioned options, and all flowing there from. Computer-aided servicing involves a servicer, such as a back end for the issuer/trustee 16, and can utilize a trustee, sub-servicer, etc. tracking and passing through payments, which the first party 4 pays to the servicer 18. Compensation can be, for example, by way of a “strip” that the issuer/trustee 16 can keep for providing credit enhancement.

Tax and insurance handling, the latter so as to be adapted to the Sharia-compliance and its respective computing, are also within the scope of corresponding computer support.

Also, a Sharia Supervisory Board of review can be utilized to ensure that all aspects of the transaction are Sharia compliant or set any Sharia-compliance detail standard, and thereby computing relating thereto, in connection with the foregoing and reporting.

In sum, it is believed that the present invention provides many advances in computer methods relating to a new financial product, its generation, implementation, securitization, fund operation and distribution, and investment management, all in connection with Sharia compliance or in carrying out Sharia-compliance standard usage. The computing consequences ripple out to many aspects of market involvement, all with computer support reaching out to unique documentation generation, transaction tracking, valuations, tax and insurance, regulatory compliance and reporting, accounting, optimizing, funds creation/management/transactions, communications with all involved parties, financial transfers (including electronic funds transfers), budgeting, reporting, secure communications (utilizing encryption), operating in accordance with data standards (e.g., data structures formed by using templates to induce entry of data corresponding to the functions at issue) and generally standardized documentation (with customization as is needed for individual transactions, with data or computed data inserted), with respective computing carried out in real-time, by relay, or with batch processing as warranted, is all contemplated along with records management and storage. Additionally, the computing encompasses distributed networks and Internet or other network communications, especially in carrying out products and services associated with the financial context.

Illustrative Documentation

A. Documents

That which is illustrative of documentation that can, depending on the implementation, be utilized at the origination and securitization stages. Though the documentation may, or may not be so detailed, would be desired for a particular embodiment, preferably the documentation includes documents generated by computer, preferably utilizing computerized data processing to produce, formant, and insert into standardized documents in generating custom documentation.

i). Multifamily Finance Agreement (MFA)

This document (the “Lease”) is functionally comparable to a loan agreement in the conventional financing world. It is executed by (1) a first financier 6, which is analogous to the lender and (2) a first party 4, which can be a single purpose entity analogous to the borrower. The financing conveys certain ownership rights to the first financier 6 (legal title remaining with the first party 4) and then leases for a specified term certain rights and responsibilities in the multifamily property back to the first party 4. Monthly rent payments are comprised of principal rent, which is analogous to principal and profit rent, which is vaguely reminiscent of interest. There are also other charges to the first party 4, which can include late charges (if permitted in an embodiment) and certain escrow items and reserves. When first party 4 pays off its obligations to first financier 6, the first party 4 can exercise a purchase or call option. In the event of a default, first financier 6 can exercise a sale or put option and, if a first party 4 fails to pay the option price, lessor can terminate the Lease and foreclose the lessee's legal title pursuant to a security instrument. The Lease need not be filed in the public record. To assure that certain rights and responsibilities (such as payment of taxes, major structural integrity, etc.) are taken on by the first party 4, the Agreement can contain provisions delegating those rights and responsibilities to the first party 4. Thus, the first party 4 holds legal title and has virtually all of the rights, responsibilities and liabilities of a typical owner of a multifamily property. The first party 4 assigns to the first financier 6 the leases and rents regarding the occupancy tenants in the same fashion, under the same terms and conditions, and with the same limitations, that a lender is assigned such interests under traditional mortgage loan financing. Computer analysis can be used to determine whether leases are complete with a predefined Sharia standard, and signal if there is a compliance problem. Because of the structural differences owing to the Lessee, occupancy tenants may be referred to in some of the documents as subtenants; however, none of this should affect the first party's 4 relationship with these occupancy tenants as compared to how it would interact with its occupancy tenants under traditional mortgage loan financing. Further, UCC Financing Statements are required as part of the Agreement to protect the financier's interest in all fixtures and other items unattached to the real estate.

ii) Multifamily Note

A note or obligation to pay (“note”) is executed by the first party 4 and evidences the first party's 4 obligation to pay monthly rent and the option price under the financing. It also provides for acceleration of first party's 4 obligation to pay certain amount in case of events of defaults as outlined in the financing documents.

iii) Multifamily Mortgage, Deed of Trust or Security Instrument

A multifamily mortgage, deed of trust or security instrument is executed by the first party. This document secures the obligations of first party 4 under the financing and note. The subject matter of this documentation is the first party's 4 remaining legal title in the multifamily property being financed as well as the first party's 4 interest in the underlying occupancy leases, if any, and any other residual interest the first party 4 holds in the multifamily property.

iv) Assignment Agreement (General)

The assignment agreement (general) assigns all rights in the property as the only recourse as to financier 8, financing agreements, collateral agreements and other documents from the initial first financier 6 (LLC) to the mortgage banker 8.

v) Assignment of Multifamily Mortgage, Deed of Trust or Security Instrument

In an embodiment, in addition to the assignment agreement in general, there can be separated out an assignment of the multifamily mortgage, the deed of trust or other security instrument of the initial financier's (LLC) interest under the agreement to the mortgage banker.

vi) Guaranty

This document is executed by one or more creditworthy individuals or entities associated with the first party. Its function is to provide credit support in the event the first party 4 violates any of the exceptions to non-recourse. First party 4 can be an SPE, thereby limiting any liabilities generally to those associated with the property and subject to the financing arrangement.

vii) Certificate of First Party

This document is executed by the first party 4 where the first party 4 provides certain representations, warranties and covenants to the financier.

viii) Replacement Reserve Agreement

This document is executed by the first party 4 and functions equivalently to the comparable document used in traditional mortgage loan financing.

ix) Repair Escrow Agreement

If the circumstances dictate its use, this document is executed by the first party 4 and functions equivalently to the comparable document used in traditional mortgage loan financing.

x) Opinions

As is customary in the traditional mortgage loan financing arena, opinions from legal counsel to the first party 4 and guarantor are required (for a religious opinion, see discussion below). These opinions of course differ correspondingly but cover the usual organizational formalities of, and execution by, the first party 4 (and the guarantor, if an entity), as well as the enforceability of the documents the lessee executes.

xi) SPE (LLC) Documents

The Special Purpose Limited Liability Corporation (first financier 6) structure is intended to satisfy two specific business objectives:

1. Provide a mechanism that satisfies the Sharia requirements of an interest free financing vehicle; and

2. Protect the product, investors in the product, and others from potential liability that may occur at the transaction level due to the first financier 6 ownership status in the financing transaction.

There are documents which are generated by computer and are utilized, e.g., to set up a distinct LLC (or Series LLC or LLCs) for each multifamily transaction. During the creation, origination, and closing process the SPE LLC (first financier 6) signs and/or is mentioned in a number of documents, such as those listed representatively below:

xii) Securitization Documents

These documents are generated by computer and are utilized for securitization purposes. These documents are issued by the issuer/trustee 16. The first document is the “Offering Circular for Multifamily Mortgage Participation Certificates” which can be adapted as a marketing tool and to provide information to prospective investors about the benefits, as well as possible risks associated with investing in such PCs. Another document generated for securitization purposes is an “Offering Circular Supplement” which can be adapted as a supplement to the former document. There is also a “Multifamily PC Certificates Agreement” generated by a computer. This agreement is a covenant between the issuer/trustee 16 and the investor(s) 14 or the fund 12. The document outlines the roles and responsibilities of parties in relation to a given PC pool of certificates. If needed, a “Multifamily PC Certificates Agreement Amendment” document is generated by a computer as well. This document outlines amendments (if any) to the agreement document. The documents share information between the issuer/trustee 16 and the investor(s) 14 and/or portfolio or fund 12.

Another document issued by the issuer/trustee 16 only to Sharia sensitive investors is a “side letter”, also generated by a computer. The side letter outlines Sharia-specific nuances of PCs backed by Sharia-compliant multifamily finance leases.

xiii) Portfolio or Fund Documents

The investor(s) 14 or portfolio or fund 12 can generate documents utilizing computer-computed data to market and provide fixed-income securities to Sharia sensitive investors. An initial document providing information relating to the portfolio or fund 12 and the underlying PCs is the “Offering Memorandum”. In addition, a “Subscription Agreement” can be executed by investors choosing to invest in the portfolio/fund 12. Further, portfolio/fund 12 can use several forms of computer generated documentation to market the portfolio/fund 12 to prospective investors, including, but not limited to investor(s) 14 letters, brochures, and presentations.

B. Interesting Provisions of the Documents

The following is a discussion of several interesting provisions of the financing documents, highlighting how the provisions can be different from their mimicked counterparts in traditional mortgage lending.

i) Regarding the Status and Rights of the First Party

a. Title

The first party 4 retains legal title to the multifamily property being financed, and conveys to first financier 6 equitable title in the multifamily property in return for cash proceeds. The first financier 6 then contemporaneously leases back virtually all of those rights to the first party. The lease places the lessee in the position of having day-to-day control of the multifamily property being financed and has a duty to maintain, insure, and operate the property. This structure can be the same regardless of whether the financing is given to refinance existing debt or to provide purchase money.

b. Federal Tax Status

Under the United States (for example) tax laws, the first party 4 has the same rights and obligations regarding the multifamily property being financed as it would have if the property were held subject to a lien of a mortgage or deed of trust under a traditional mortgage loan financing structure. For example, the first party 4 is entitled to deduct profit rent as if it were interest and is entitled to depreciate the multifamily property. A detailed analysis and explanation of these tax matters can be generated for potential Lessees.

c. Single Asset Entities

The first party 4 can be a single purpose entity, or otherwise adheres to the structural requirements imposed by traditional mortgage lenders and the issuer/trustee 16, for example, term of existence, non-foreign ownership, etc.

ii. Regarding Repayment of the Financing

a. Cost of Financing

The then-applicable fixed market rate can be selected by the first party 4 in a process functionally equivalent to the process for locking an interest rate under the applicable the issuer/trustee 16 multifamily loan program. That rate can be reduced by a preferential yield concession and then used to set the amount of profit rent.

b. Late Charge

A late charge can be imposed consistent with Sharia requirements.

c. Monthly Payment

The monthly payment under the financing is, as in comparable traditional mortgage loan financing, due on the first day of each month and is payable using customary banking processes, including electronic funds transfer and automated payment. The monthly payment includes principal rent (comparable to principal) as well as profit rent (comparable to interest).

d. Non-Recourse

The financing is non-recourse to the first party 4 in the same manner that traditional mortgage loan financing is non-recourse to the borrower. The financing has exceptions to its non-recourse status that are comparable to the exceptions to non-recourse that are found in traditional mortgage loan financing. In most cases, one or more creditworthy individuals or entities connected to the first party 4 sign a guaranty covering the exceptions to non-recourse (i.e., non-recourse to first financier 6 as well, or in any liabilities associated with ownership consistent with Sharia criteria regarding ownership).

e. Prepayment Premium

The financing contains a prepayment premium comparable to that contained in traditional mortgage loan documents, combining a yield maintenance formula with (for example) a 1% floor and a 90-day period at the end of the term, during which the financing can be prepaid in full without premium. As is the case with traditional mortgage lending, the application of insurance loss proceeds and condemnation awards do not incur a prepayment premium regardless of their timing.

iii. Regarding the Financed Property

a. Title Insurance Coverage and Premiums

Title insurance covers the Security Instrument securing the Note, which evidences the financial obligations arising under the financing. That coverage is in form and substance mimicking the lenders policy of title insurance that is obtained for traditional mortgage loan financing. Premiums mimic those charged for comparable, lenders policies.

b. Replacement Reserve and Completion/Repair Escrow

Replacement reserves and completion/repair escrows are computed and administered in the same fashion as in traditional mortgage loan financing, and deferrals of deposit can be granted under the same circumstances mimicking the traditional mortgage lending market. Any obligation to pay a return on replacement reserves can be imposed on the servicer.

c. Taxes and Hazard Insurance Premiums

The first party 4 has the same duties relative to the payment of taxes, assessments, hazard insurance premiums and similar charges, mimicking traditional mortgage loan financing. Furthermore, the first financier 6 can have the same right to collect such payments in monthly installments, in escrow, mimicking a lender under traditional mortgage loan financing.

d. Insurance and Condemnation Proceeds

Insurance and condemnation proceeds are also carried out a Sharia-compliant manner. For example, compared to the traditional mortgage loan arena, the first party 4 can have the same duty to prosecute insurance claims arising from damage to the multifamily property being financed and to defend condemnation actions involving the multifamily property. Similarly, the finance is entitled to take action on its own regarding insurance claims or condemnation proceedings under the same circumstances in which it might intervene under the documents, mimicking traditional mortgage loan financing. The first financier 6 has mimicking (vis-à-vis traditional mortgages) powers and limitations with respect to whether a payment of insurance proceeds or a condemnation award is to be applied to the outstanding principal rent (compare to the principal of a traditional mortgage loan) or whether those sums are to be used to restore the multifamily property being financed. Where there are losses, Sharia criteria can require risk sharing.

iv. Regarding Servicing

a. Subordinate Financing

The servicer 18 (and not the financiers) can be conditionally obligated to support a subordinate mortgage loan on the multifamily property being financed. The mortgage documents for a subordinate loan can vary from the traditional forms for such financing because of the peculiarities of the underlying financing structure that precedes it in priority. In coordination with issuer/trustee 16, forms in generated can be using a computer and computer-computed data.

b. Assumption

The first party 4 can have the same right to assign or transfer its interest in the multifamily property being financed so as to mimic traditional mortgage loan financing. Similarly, the limitations on such transfers and assignments that are imposed on borrowers in the traditional mortgage lending arena can be imposed on first party 4 by the finance. So, for example, a transfer of first party's 4 interest(s) in the multifamily property being financed can be permitted only to an entity that is reviewed and approved (not pursuant to the document, necessarily) by the Servicer 18 on behalf of the financier. Correspondingly, the transfer of interests in first party 4 itself can be limited in a fashion that mimics the limitations imposed on similar transfers of interests in a borrower.

c. Payoff and Release (Call Option)

When the first party 4 has paid all required amounts due, including but not limited to “principal rent” (compare with principal), and the “profit rent” (compare with interest) through the date of payment, then the first party 4 can be entitled to purchase financier's interest in the multifamily property for a specified option price. This can be tracked by computer, too. Upon such payment, the financing can terminate, the lien of the Security Instrument released and the Multifamily Note marked “cancelled” is returned to the first party. This process can have the same legal effect and can place the first party 4 in the same position that it would find itself had it paid off a traditional mortgage loan.

d. Default and Foreclosure (Put Option)

Upon default and the expiration of any applicable grace or notice period, first financier 6 may exercise the put option. The option price is comparable to a traditional accelerated payoff amount and can include such items as unpaid principal rent and profit rent through the date of payment, plus any negative escrow balance, any sums that the servicer 18 and first financier 6 may have advanced to protect the multifamily property being financed, late charges (if allowed in a Sharia-compliant embodiment), the applicable prepayment premium, if any, and any out-of-pocket items such as costs of collection, etc. This can be tracked by computer, as well. If the option price remains unpaid beyond the applicable deadline, then simultaneous enforcement actions begin. These enforcement actions are forfeiture of the first party's 4 interest under the financing and foreclosure of the first party's 4 interest under the security instrument. These actions can involve local law procedures and can vary from state to state, nation to nation. At the conclusion of the proceedings, first financier 6 can typically either be paid off completely or can hold full title to the multifamily property. If it takes title as a result of the foreclosure proceeding, the first financier 6 or its assignee can then dispose of the real estate in the traditional fashion. Variations in the result may occur where, for example, the first party 4 commits one of the prohibited non-recourse exception acts, and the property value deteriorates such that first financier 6 can seek a recourse recovery, or deficiency against the guarantor and/or the first party 4.

v. Secondary Market

The following is of special interest to the second financier 8/servicer 18 and issuer/trustee 16 (e.g., Freddie Mac, referenced as an example, but intended to include any equivalent institution, foreign or domestic), and of less interest to the prospective first party. The assignments to the second financier 8 and, in turn, to issuer/trustee 16, e.g., in the order listed below.

a. Pricing

The rate lock process can be conducted by the mortgage banker in cooperation with the first party 4 and a rate lock provider 5. The rate and price can be pegged to readily available, public pricing information.

b. Assignment to Mortgage Banker

The mortgage banker acts as originator of the transaction in finding the first party 4, underwriting the transaction, and issuing a commitment. That commitment specifies the identity of the initial financier 6, e.g., a special purpose entity. Simultaneous with the closing of the financing and the execution of the documents listed above, the first financier 6 assigns all of its interest in the foregoing to the second financier 8. That assignment can expressly disclaim liability to third parties arising from environmental matters or common torts, such as so-called “slip-and-fall” cases, all of which liabilities are retained by the first party 4. This assignment in its interests in the property can be evidenced by (1) an endorsement to the multifamily note, (2) a recorded assignment of the security instrument, and (3) and unrecorded general assignment of the unrecorded documents, including the financing.

The second financier 8, as successor lessor, should, if required avoid the risks of ownership and be left in virtually the same position as a traditional lien holder because (1) the first party's 4 indemnity in the financing covering such matters, (2) the first party's 4 duty to maintain insurance for various relevant risks, (3) the express retention of certain risks by the first party, and (4) the fact that legal title to the property being financed is retained by the first party 4 (non-recourse to property at the first financier 6 level and these rights get assigned). This is all done notwithstanding second financier's 8 equitable ownership interest in the property.

c. Assignment to the Freddie Mac (or Equivalent)

The mortgage banker can assign all of its interest to The issuer/trustee 16. The assignment can be evidenced in the same manner as described above for the assignment from the initial first party 4 to the second financier 8. The second financier 8 issues a servicing advisory letter to the first party 4 explaining that the second financier 8 can retain the following obligations, as Servicer 18: (1) the obligation to pay interest on escrows, if required, (2) the obligation to pay interest on reserves, if required, and (3) the conditional obligation to provide subordinate financing. The placement of these obligations is necessitated by the underlying principles dictating the special financing structure so that the PC cannot be rendered unacceptable to the portfolio or fund 12 and as required by law.

d. Securitization

The financing program results in suitable collateral for the issuer/trustee 16 securitization for sale in the manner of asset-backed securities, and/or pooled for the same. Ultimately, the financing product backs the issuance by the issuer/trustee 16 of Participation Certificates (“PCs”) to be placed in a portfolio or fund 12, as discussed above. The portfolio or fund 12 can be useful to satisfy the inventor's 14 perceived demand among Islamic capital markets investors for a liquid, credit-enhanced, fixed-income investment vehicle not currently available in the marketplace. Such aspects have computer operations mimic those known in traditional mortgage secondary market, however, the present approach of course differs in that it is uniquely responsive to Sharia-compliance requirements.

vi) Marketing

This product may require special explanation, which can be generated by computer. An “illustration” can demonstrate that a Sharia-compliant financing structure operates mimicking regular mortgages, from origination to investments held in a portfolio or fund 12. The computer-produced illustration can show a lease financing structure that can essentially result in the same economics, cash flows, legal rights, and liabilities, and property management responsibilities provided in the conventional mortgage market. Further, although the transaction is a finance lease rather than a loan, the underlying legal documentation can take a form that mimics what is familiar to conventional borrowers. The financing documentation package can include computer-generated documentation (mimicking a Loan Agreement), note, security instrument, and all other necessary ancillary documents such as a replacement reserve agreement, completion/repair escrow agreement, exceptions to non-recourse guaranty, etc.

From an execution point of view, the first party 4 mimics processes and procedures of a conventional mortgage transaction. In particular, the first party's 4 relationship with the second financier 8 can be compared to that of lender/borrower relationship but this is not necessarily the intention and the result may be different. The second financier 8, as the servicer 18 can be the primary contact for the first party 4 during the financing process from origination through servicing.

System Control

To carry out such a financial transaction, there can be a control system governing one or more computing devices or computers 20 in the system. The control system may be carried out with a switching system, preferably a selectable switching system, which at a simple level can be menu displayed on a monitor. The control system may be structured to offer choices to solicit predetermined data (set a Sharia compliance standard, enter transaction date, etc.) or trigger predetermined operations, such as selectably engaging operations unique to the computer system context disposed for carrying out a transaction such as that discussed herein, or a part thereof. More particularly, one or more of the computers 20 can be controlled by program instructions to implement a predetermined Sharia-compliance standard.

Sharia-Compliance Standards

In the computing context, such a standard can pertain to one or more of the following:

Determine whether:

A. the purchase of property by financier 6 from first party 4 (sponsor) is free of riba.

B. the assignment of occupancy rents and/or occupancy leases is free from riba.

C. the lease agreement between financier 6 and first party 4 is free or riba and/or contains no interest in any lease agreement term.

D. any rent(s) and/or component(s) is calculated in a manner not inconsistent with the Sharia.

E. any late charge(s) is addressed in manner not inconsistent with the Sharia.

F. any loss sharing/risk sharing is addressed in manner not inconsistent with the Sharia (e.g. loss(es) not covered by insurance, environmental contamination, condemnation, etc. provisions).

G. any prepayment and/or cancellation provision(s), if any, is not inconsistent with the Sharia.

H. any recourse and/or non-recourse provision(s) is not inconsistent with Sharia.

I. any provision(s) related to the assignment of lease and/or treatment of occupancy rent(s) and occupancy lease(s) are not inconsistent with the Sharia.

J. any/all assignments)/sale(s) of property interest is/are transferred in a manner not inconsistent with the Sharia.

K. any term(s) of the Purchase Option is/are free from riba.

L. any term(s) of the Sales Option is/are free from riba.

M. any separate obligation for payment (Multi-Family Note) under the lease agreement between the financier 6 and first party 4 is free from riba and/or contains no interest.

N. any term(s) of any security interest(s) (e.g., any mortgage, guaranty, and/or other enhancement is free from interest.

O. any term(s) of the PC (or similar security) represents interest in the property and/is free from riba.

P. any term(s) of a warehouse arrangement is/are not inconsistent with the Sharia.

Q. any term under which price is determined (e.g., rate lock) in a manner satisfactory for the Sharia.

The foregoing are merely illustrative, and any one or more can be implemented in any one or more of computers 20. The control means can be carried out with program instructions producing a monitor in which one or more of the selections can be made and applied to a particular transaction. Program instructions can also permit data processing means resident on one of computers 20 to be arranged for receiving information into memory, the information enabling the transaction such that the data processing means includes the control means disposed to apply the Sharia compliance standard to the information control said one or more of computers 20 in carrying out a transaction compliant with the standard. Coincident with use of a data entry template or selection mechanism, a corresponding data structure can be stored in memory.

Though the general structures of embodiments herein can be Sharia-compliant, particular implementations are best checked on a case-by-case, and within any computer 20 involved in the transaction, not only for enabling double-checking, to help ensure Sharia compliance, but also to view the transaction from the different points of view of the parties involved in the transaction. Indeed, the standards applied by one such computer 20 may, in some embodiments, be different from the standards applied resident at another computer 20.

Communications

With further reference to FIGS. 1-2, note that any or all of the computers 20 can interact with another of the computers 20 to cooperate in carrying out respective aspects discussed herein. Viewed in this manner, in addition to computing carried out at any of the computers 20, the computers 20 can utilize computer-to-computer communication devices and programming enabling use thereof, as well as communications programming, e.g., real time, relay, etc. Thus, each computer can be viewed as an electronic transmission apparatus for handling communications to implement a Sharia compliance standard in a transaction, the apparatus including: program control means governing a first computer in communication with a second computer, the first computer and the second computer cooperating to implement a transaction wherein a first party obtains property financing from a first financier by providing equitable title to the first financier and incurring obligations under a lease to the property, and wherein the first financier obtains funding for the financing from a second financier by providing at least some of the first financier's rights in the property, wherein the program control means disposed is to apply a Sharia compliance standard to data processing means at least one of the computers in carrying out the transaction compliant with the standard; and electronic transmission means enabling sending communication to an other of the computers to facilitate the computers cooperating in carrying out the transaction. The apparatus can further include a network enabling the computers 20 to communicate.

Similarly each of computers 20 can be viewed as an electronic receiver apparatus for handling communications to implement a Sharia compliance standard in a transaction, the apparatus including: program control means governing a first computer in communication with a second computer, the first computer and the second computer cooperating to implement a transaction wherein a first party obtains property financing from a first financier by providing equitable title to the first financier and incurring obligations under a lease to the property, and wherein the first financier obtains funding for the financing from a second financier by providing at least some of the first financier's rights in the property, wherein the program control means disposed is to apply a Sharia compliance standard to data processing means at least one of the computers in carrying out the transaction compliant with the standard; and electronic receiver means enabling receipt of communication from an other of the computers to facilitate the computers cooperating in carrying out the transaction. And such an apparatus can further include an Internet network enabling the computers to communicate.

More broadly, however, the terms and expressions which have been employed herein are used as terms of teaching and not of limitation, and there is no intention, in the use of such terms and expressions, of excluding equivalents of the features shown and described, or portions thereof, it being recognized that various modifications are possible within the scope of the embodiments contemplated and suggested herein. Further, various embodiments described and suggested herein. Although the disclosure herein has been described with reference to specific embodiments, the disclosures are intended to be illustrative and are not intended to be limiting. Various modifications and applications may occur to those skilled in the art without departing from the true spirit and scope of the invention as defined in the appended claims.

Thus, although only a few exemplary embodiments have been described in detail above, those skilled in the art will readily appreciate that many modifications are possible in the exemplary embodiments without materially from the novel teachings and advantages herein. Accordingly, all such modifications are intended to be included within the scope defined by claims. In the claims, means-plus-function claims are intended to cover the structures described herein as performing the recited function and not only structural equivalents, but also equivalent structures. Thus, although a nail and a screw may, not be structural equivalents in that a nail employs a cylindrical surface to secure wooden parts together, whereas a screw employs a helical surface, in the environment fastening wooden parts, a nail and a screw may be equivalent structures.

We claim:

1. Apparatus for controlling a computer system enabling a transaction, the apparatus comprising:
data processing means arranged for receiving information into memory, the information enabling a transaction wherein a first party obtains property financing from a first financier by providing equitable title to the first financier and incurring obligations under a lease to the property, and wherein the first financier obtains funding for the financing from a second financier by providing at least some of the first financiers rights in the property, wherein the data processing means includes control means disposed to apply a Sharia compliance standard to the information to control the computer system in carrying out the transaction compliant with the standard.

2. Apparatus for controlling a computer in a system enabling a transaction, the apparatus comprising:
a plurality of computers programmed to cooperate in enabling a transaction wherein a first party obtains property financing from a first financier by providing equitable title to the first financier and incurring obligations under a lease to the property, and wherein the first financier obtains funding for the financing from a second financier by providing at least some of the first financiers rights in the property;
data processing means, at one of the computers, arranged for receiving information into memory, the information defining a portion of the transaction; and
control means disposed to apply a Sharia compliance standard to the information to control the one of the computers in carrying out the transaction compliant with the standard.

3. The apparatus of claim 2, further including
data processing means, at a second of the computers, arranged for receiving respective information into memory, the respective information defining a portion of the transaction; and
control means disposed to apply a respective Sharia compliance standard to the respective information to control the second of the computers in carrying out the transaction compliant with the respective standard.

4. The apparatus of claim 3, wherein the standard and the respective standard are not identical.

5. A computer-aided method, the method including:
converting input information, representing a first party financing property by providing equitable title and incurring obligations under a lease to the property with a first financier, into input signals;
converting input information, representing a first financier obtaining funding for the financing from a second financier by providing at least some of the first financiers rights in the property received from the first party, into input signals;
communicating the input signals to a computer system;
computing, with the computer system, to process data corresponding to the input signals to produce an illustration of an arrangement of the funding and the financing; and
producing, at an output device in communication with the computer system, an illustration of the arrangement.

6. The method of claim 5, further including evaluating the arrangement according to a predefined Sharia compliance standard.

7. A computer-aided method, the method including:
entering into a computer system data defining an arrangement in which a first party obtains financing for property by providing equitable title and incurring obligations under a lease to the property with a first financier, and the first financier obtains funding for the financing from a second financier by providing at least some of the first financier's rights in the property received from the first party, wherein the arrangement complies with a predetermined Sharia compliance standard;
computing, with the computer system, to process the data to generate an optimization of the arrangement; and
producing, with the computer system, implementation documentation to carry out the arrangement according to the optimization.

8. The method of claim 7, wherein the producing implementation documentation includes producing documentation according to a predefined Sharia compliance standard.

9. A method for monitoring a financing arrangement, the method including:
monitoring, with a computer, notice of at least one payment required from a first party, the payment defined by an obligation corresponding to a lease corresponding to financing from a first financier receiving equitable title to the property and associated with funding for the financing obtained from a second financier receiving a beneficial interest in the property;
determining, electronically, whether the obligation is not violated;
if the obligation is violated, signaling a notice of the violation;
determining, electronically, whether the obligation is satisfied for a corresponding time period;
if the obligation is satisfied for the time period, then repeating the monitoring for a subsequent time period;
determining, electronically, whether the obligation is completely satisfied; and
if the obligation is completely satisfied, then signaling a notice that the obligation is completely satisfied, and terminating the monitoring to correspond with exercising an option by the first party to obtain full right, title, and interest in the property.

10. The method of claim 9, further including defining the obligation pursuant to a predefined Sharia compliance standard.

11. A computer-aided method, the method including:
storing in a computer memory a data structure recording a multiplicity of financings defined by respective agreements wherein, respectively, a first party obtains financing for property by providing equitable title and incurring obligations under a lease to the property with a first financier and whereby the first financier obtains funding for the financing from a second financier by providing at least some of the first financier's rights in the property received from the first party, at least one of the financings being compliant with a Sharia standard;
updating the data structure with payment data;
identifying from the payment data any of the financings in which all said obligations have been satisfied;
and for each of the financings in which all said obligations have been satisfied, generating notice of an option defined as exercisable by the first party so as to cause the interests to vest in the first party.

12. A computer-aided method, the method including:
forming a data standard by eliciting data with a Sharia-compliance lending template, the template including data fields configured to receive entry of data defining an arrangement of a first party obtaining financing for property by providing equitable title and incurring obligations under a lease to the property with a first financier, and the first financier obtaining funding for the financing from a second financier by providing at least some of the first financier's rights in the property received from the first party; and
storing in a memory of a computer data structured in accordance with the data standard.

13. A method of using a computer system to implement a financing, the method including:
providing a database of data relating to applications for financing property according to a Sharia-compliance standard, wherein the applications are defined by:
obtaining, at a first party, financing for property by providing equitable title and incurring obligations under a lease to the property with a first financier;
obtaining, at the first financier, funding for the financing from a second financier by providing at least some of the first financier's rights in the property received from the first party; and
testing an indicator in the database, the indicator indicating status of the applications; and
a program accessing the database to analyze the status in carrying out at least one closing corresponding to at least one of the applications.

14. A computer-aided method for carrying out an option on a financing, the method including:
receiving information into a memory specifications defining the option to acquire property, the option defined in accordance with a Sharia standard-compliant transaction in which a first party obtains financing for property by providing equitable title and incurring obligations under a lease to the property with a first financier, and the first financier obtains funding for the financing from a second financier by providing at least some of the first financier's rights in the property received from the first party, such that satisfaction of the obligations enables execution of the option so that the first party extinguishes the interests;
evaluating satisfaction of the obligations with a computer; and if complete satisfaction is detected, signaling enablement of the option.

15. A method of generating financing documentation, the method including:
providing a database of data containing model documents corresponding to financing structured according to a Sharia-compliance standard, wherein the model documents are defined by:
obtaining, at a first party, financing for property by providing equitable title and incurring obligations under a lease to the property with a first financier;
obtaining, at the first financier, funding for the financing from a second financier by providing at least some of the first financier's rights in the property received from the first party; and
controlling a computer system with a program to enable an analysis of the funding structure applied to a property, enable access to the database to obtain at least one of the model documents, and enable modification the at least one document in carrying out an acquisition of the property.

16. A computer-aided method for producing an asset-backed security, the method comprising:
storing in a computer memory a plurality of financing arrangements, at least one of the financing arrangements defined by:
a first party obtaining property by providing equitable title and incurring obligations under a lease to the property with a first financier; and
the first financier obtaining funding from a second financier by providing at least some of the first financier's rights in the property received from the first party;
identifying at least one of the financing arrangements that is compliant with a predefined Sharia standard; and
forming an asset-backed security including the at least one of the financing arrangements that is compliant with a predefined Sharia standard, by preparing documentation operatively associating the set of multiple financing arrangements with the security.

17. The apparatus of any one of claims 1-4, wherein the property is a multifamily dwelling property.

18. The apparatus of any one of claims 1-4, wherein the property is a single family dwelling property.

19. The apparatus of any one of claims 1-4, wherein the property is neither a single family dwelling property nor a multifamily dwelling property.

20. An electronic transmission apparatus for handling communications to implement a Sharia compliance standard in a transaction, the apparatus including:
program control means governing a first computer in communication with a second computer, the first computer and the second computer cooperating to implement a transaction wherein a first party obtains property financing from a first financier by providing equitable title to the first financier and incurring obligations under a lease to the property, and wherein the first financier obtains funding for the financing from a second financier by providing at least some of the first financier's rights in the property, wherein the program control means disposed is to apply a Sharia compliance standard to data processing means at least one of the computers in carrying out the transaction compliant with the standard; and
electronic transmission means enabling sending communication to an other of the computers to facilitate the computers cooperating in carrying out the transaction.

21. The apparatus of claim 20, further including a network enabling the computers to communicate.

22. An electronic receiver apparatus for handling communications to implement a Sharia compliance standard in a transaction, the apparatus including:
program control means governing a first computer in communication with a second computer, the first computer and the second computer cooperating to implement a transaction wherein a first party obtains property financing from a first financier by providing equitable title to the first financier and incurring obligations under a lease to the property, and wherein the first financier obtains funding for the financing from a second financier by providing at least some of the first financier's rights in the property, wherein the program control means disposed is to apply a Sharia compliance standard to data processing means at least one of the computers in carrying out the transaction compliant with the standard; and
electronic receiver means enabling receipt of communication from an other of the computers to facilitate the computers cooperating in carrying out the transaction.

23. The apparatus of claim 22, further including an Internet network enabling the computers to communicate.

24. A computer-readable media tangibly embodying a program of instructions executable by a computer to perform the steps of:
receiving definition of a transaction wherein a first party obtains property financing from a first financier by providing equitable title to the first financier and incurring obligations under a lease to the property, and wherein the first financier obtains funding for the financing from a second financier by providing at least some of the first financiers rights in the property; and
generating output including the documentation of the transaction.

25. The media of claim 34, wherein the media comprises at least one of a RAM, a ROM, a disk, an ASIC, and a PROM.
